(19) United States
(12) Patent Application Publication
(10) Pub. No.: US 2012/0166739 A1
(43) Pub. Date: Jun. 28, 2012

(54) MEMORY MODULE AND METHOD FOR ATOMIC OPERATIONS IN A MULTI-LEVEL MEMORY STRUCTURE

(75) Inventors: Chi-Chang Lai, Hsinchu County (TW); Shan-Chih Wen, Hsinchu County (TW)

(73) Assignee: ANDES TECHNOLOGY CORPORATION, Hsin-Chu City (TW)

(21) Appl. No.: 12/975,359

(22) Filed: Dec. 22, 2010

(51) Int. Cl. G06F 12/00

(52) U.S. Cl. 711/149; 711/E12.001

(57) ABSTRACT

A memory module and a corresponding method for handling atomic operations in a multi-level memory system (MLMS) are provided. The memory module receives load and store operations of the atomic operations from a data processing engine (DPE) or an upper level memory module (ULMM). The memory module logs the load operation and/or forward the load operation to a lower level memory module (LLMM) according to predetermined conditions such as cacheability or whether there is a data hit or not. In addition, the memory module executes the store operation, inhibits the store operation, or forwards the store operation to an LLMM according to predetermined conditions such as cacheability, data hit, or whether there is a matching load operation logged in the memory module. The memory module and the method ensure correct, consistent and efficient execution of atomic operations for all DPEs sharing the MLMS.

### BACKGROUND OF THE INVENTION

1. Field of the Invention

The present invention relates to atomic operations. More particularly, the present invention relates to a memory module and a method for atomic operations in a multi-level memory structure (MLMS).

2. Description of the Related Art

An atomic operation is a set of load and store operations that are combined into one execution process, which disallow others to modify related data in between the load and store operations. A mechanism for handling atomic operations is very important for a memory structure shared by multiple data processing engines (DPEs). Here each DPE is a general-purpose processor or a special-purpose processor such as digital signal processor (DSP). With atomic operations, data access operations of a DPE can be guaranteed to be correct and consistent without interferences from the other DPEs.

The implementation of atomic operations is very important for a shared memory system. However, conventional techniques only solve the problem of implementing atomic operations in single-level memory systems. The problem of implementing atomic operations in an MLMS remains unsolved.

### SUMMARY OF THE INVENTION

Accordingly, the present invention is directed to a memory module and a corresponding method for handling atomic operations in an MLMS. The memory module and the method ensure correct, consistent and efficient execution of atomic operations for all DPEs sharing an MLMS.

According to an embodiment of the present invention, a memory module for atomic operations in an MLMS is provided. The memory module includes a regular memory unit (RMU), an atomic operation tag (AOT) unit, and an atomic operation logic unit (AOLU). The RMU stores the data of the memory module. The AOT unit stores AOTs corresponding to the atomic operations. The AOLU is coupled to the RMU and the AOT unit. The AOLU executes a handling process to handle the atomic operations.

The aforementioned handling process includes the following steps. First, receive a load-locked operation (LLO) of an atomic operation from a DPE or an upper level memory module (ULMM). Log the LLO as an AOT in the AOT unit when a first condition is true. Forward the LLO to a lower level memory module (LLMM) when a second condition is true. The ULMM connects to the memory module on the side nearer to the DPE. The LLMM connects to the memory module on the side farther from the DPE.

In an embodiment of the present invention, the first condition is that the cacheability of the LLO does not allow the memory module to keep a copy of the data to be accessed by the LLO or the cacheability of the LLO affiliates to the memory module, and the LLO is not logged in the AOT unit. The second condition is that the cacheability of the LLO does not allow the memory module to keep the copy of the data to be accessed by the LLO.

In another embodiment of the present invention, the first condition is that the cacheability of the LLO affiliates to the memory module and the LLO is not logged in the AOT unit. The second condition is that the cacheability of the LLO does not allow the memory module to keep a copy of the data to be accessed by the LLO.

In another embodiment of the present invention, the first condition is that the data to be accessed by the LLO is stored in the memory module or will be brought into the memory module for the LLO, and the LLO is not logged in the AOT unit. The second condition is that the data to be accessed by the LLO is not stored in the memory module and will not be brought into the memory module for the LLO. When any data in the RMU is invalidated due to a cache data replacement scheme, the AOLU invalidates all AOTs in the AOT unit matching the address of the invalidated data.

According to another embodiment of the present invention, the aforementioned handling process executed by the AOLU includes the following steps. First, receive a store-conditional operation (SCO) of an atomic operation from a DPE or a ULMM. Invalidate all AOTs in the AOT unit matching the memory address to be accessed by the SCO, execute the store operation of the SCO, and return a success status to the DPE or the ULMM when a third condition is true. Inhibit the store operation of the SCO and return a failure status to the DPE or the ULMM when a fourth condition is true. Forward the SCO to a LLMM and returning a status returned by the LLMM to the DPE or the ULMM when a fifth condition is true.

In an embodiment of the present invention, the third condition is that there is an AOT in the AOT unit with the same key information as that of the SCO and the data to be accessed by the SCO is stored in the memory module. The fourth condition is that there is no AOT in the AOT unit with the same key information as that of the SCO. The fifth condition is that there is an AOT in the AOT unit with the same key information as that of the SCO and the data to be accessed by the SCO is not stored in the memory module.

In another embodiment of the present invention, the third condition is that the cacheability of the SCO affiliates to the memory module and there is an AOT in the AOT unit with the same key information as that of the SCO. The fourth condition is that the cacheability of the SCO affiliates to the memory module and there is no AOT in the AOT unit with the same key information as that of the SCO. The fifth condition is that the cacheability of the SCO does not allow the memory module to keep a copy of the data to be accessed by the SCO.

In another embodiment of the present invention, the third condition is that there is an AOT in the AOT unit with the same key information as that of the SCO. The fourth condition is that there is no AOT in the AOT unit with the same key information as that of the SCO and the data to be accessed by the SCO is stored in the memory module. The fifth condition is that there is no AOT in the AOT unit with the same key information as that of the SCO and the data to be accessed by the SCO is not stored in the memory module.

According to another embodiment of the present invention, a method for atomic operations in the aforementioned MLMS is provided. This method includes the handling process for the LLO executed by the aforementioned AOLU.

According to another embodiment of the present invention, another method for atomic operations in the aforementioned MLMS is provided. This method includes the handling process for the SCO executed by the aforementioned AOLU.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing a multi-level memory system according to an embodiment of the present invention.

FIG. 2 is a schematic diagram showing a memory module of the multi-level memory system in FIG. 1.

FIG. 3-FIG. 9 are flowcharts of a method for atomic operations in a multi-level memory structure according to various embodiments of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

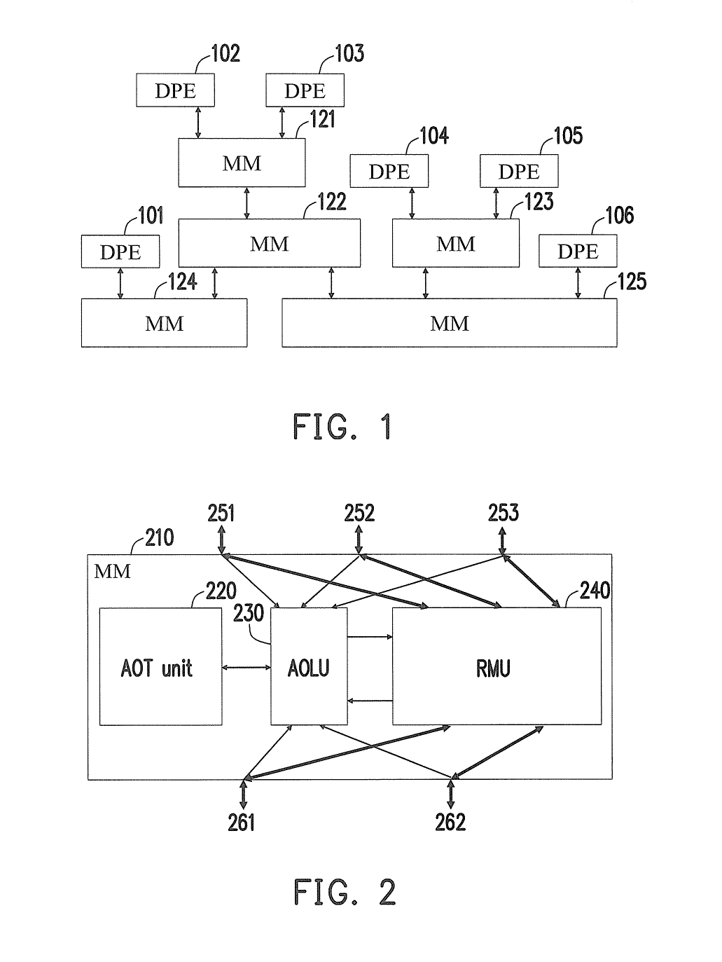

FIG. 1 is a schematic diagram showing an exemplary MLMS according to an embodiment of the present application. The MLMS in FIG. 1 includes six DPEs 101-106 and five memory modules (MMs) 121-125. The MMs 121-125 are cascaded together so that each of them may supply or consume data associated with the access transactions initiated by its ULMMs or by the DPEs. Each of the upper level MMs 121-123 may be a cache memory or a shadow memory. For example, the MMs 121 and 122 may work like a level 1 (L1) cache and a level 2 (L2) cache, respectively. The lowest level MMs 124 and 125 are main memories where authentic copies of data reside.

The concepts of ULMMs and LLMMs are relative. For any MM in the MLMS, a ULMM is an MM that connects to the aforementioned MM on the side nearer to the DPEs, while an LLMM is an MM that connects to the aforementioned MM on the side farther from the DPEs. For example, the MM 121 is a ULMM of the MM 122 and the MMs 124 and 125 are LLMMs of the MM 122. The MMs 122 and 123 are ULMMs of the MM 125. The MMs 121 and 123 have no ULMM. The MMs 124 and 125 have no LLMM. An MM in an MLMS may forward memory access transactions received from its ULMMs to its LLMMs.

In this embodiment of the present invention, an atomic operation includes a pair of corresponding memory access operations, namely, a load operation and a store operation. The load operation of an atomic operation is named LLO. The store operation of an atomic operation is named SCO. The LLO and SCO of an atomic operation are initiated by a DPE in FIG. 1.

Each MM in FIG. 1 may have the same or different design and structure, but always includes at least an AOT unit and an AOLU. FIG. 2 is a block diagram of an MM 210 according to an embodiment of the present invention. Each MM 121-125 in FIG. 1 may be implemented with the same or different structure as that of the MM 210 in FIG. 2, with at least one AOT unit and one AOLU. The MM 210 includes an AOT unit 220, an AOLU 230, and an RMU 240. In addition, the MM 210 has one or multiple sets of interfaces connected to its ULMMs (such as the interfaces 251-253) and one or multiple sets of interfaces connected to its LLMMs (such as the interfaces 261-262).

The RMU 240 includes a memory cell array for data storage and RMU access control logic. The RMU 240 stores and provides data of the MM 210. The AOT unit 220 stores AOTs corresponding to the atomic operations. The AOLU 230 is coupled to the RMU 240 and the AOT unit 220. The AOLU 230 logs the atomic operations received by the MM 210 as AOTs in the AOT unit 220. In addition, the AOLU 230 executes a handling process to handle the atomic operations received by the MM 210.

The AOLU 230 manages the AOTs in order to handle the atomicity process of the atomic operations. Each of the AOTs includes the key information of a corresponding atomic operation. The key information includes the identification (ID) of the corresponding atomic operation and/or the memory address accessed by the corresponding atomic operation. In addition, each AOT includes a valid bit. The ID of an atomic operation is assigned by the DPE that initiates the atomic operation. One or more IDs may be used by one DPE. If there is only one DPE connected to an MM along all upper interface paths of the MM and only one ID is used by the DPE, the ID of the atomic operations initiated by the DPE may be omitted. The memory address of an atomic operation may be omitted as well. In this case, the corresponding AOT has no memory address and any other atomic operations accessing the same memory module match the aforementioned AOT. The concept of AOT matching is explained later. Both the LLO and the SCO of an atomic operation includes the ID and the memory address of the atomic operation. The valid bit indicates whether an AOT is valid or not. An invalid AOT in the AOT unit 220 is regarded as unused storage space and may be overwritten by a new AOT entry.

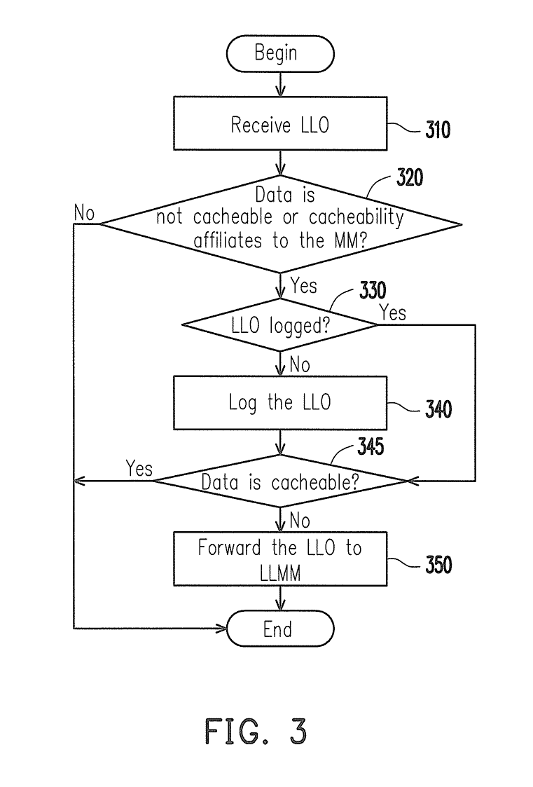

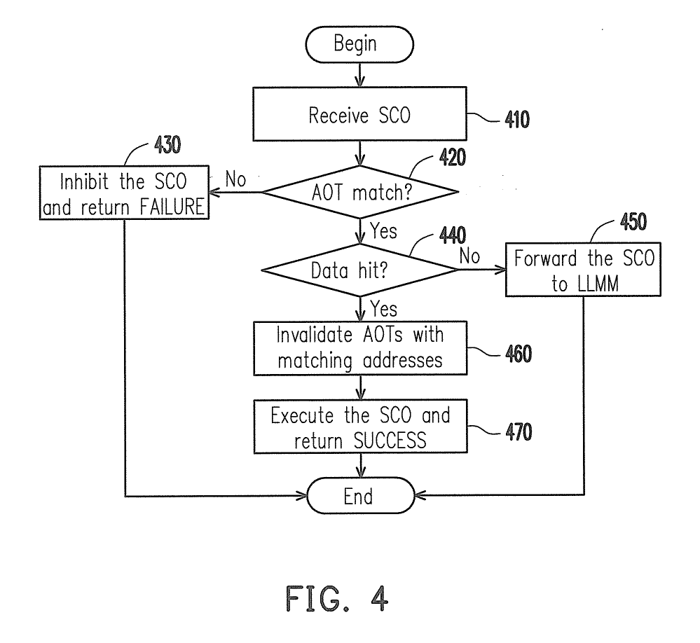

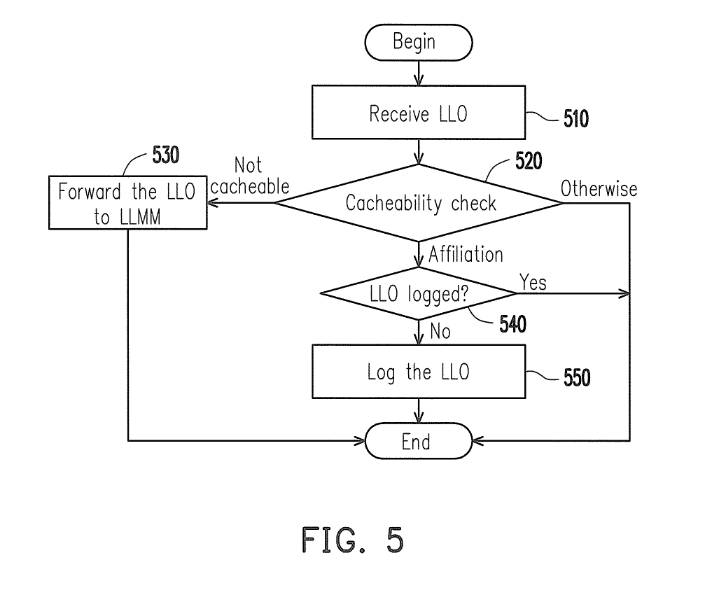

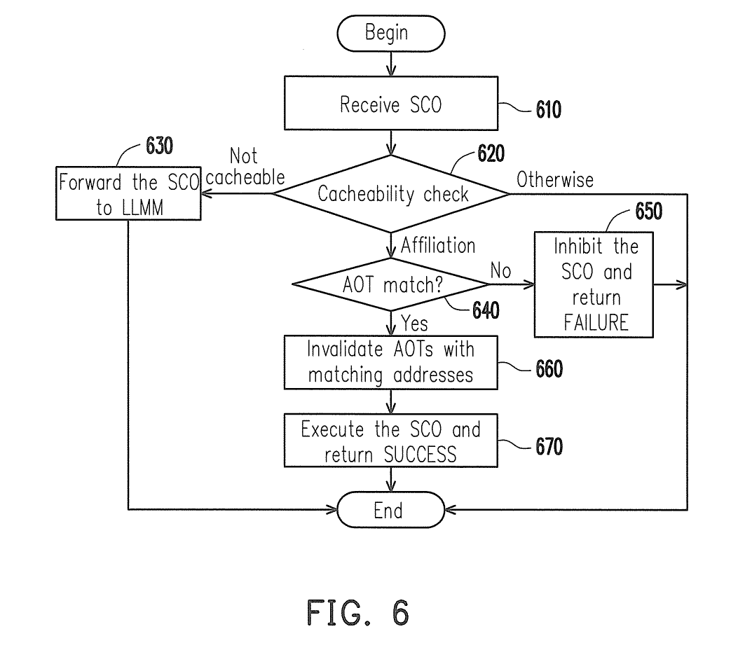

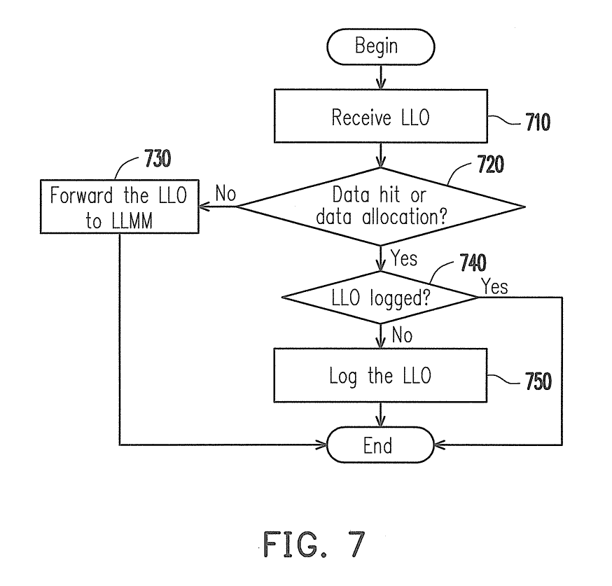

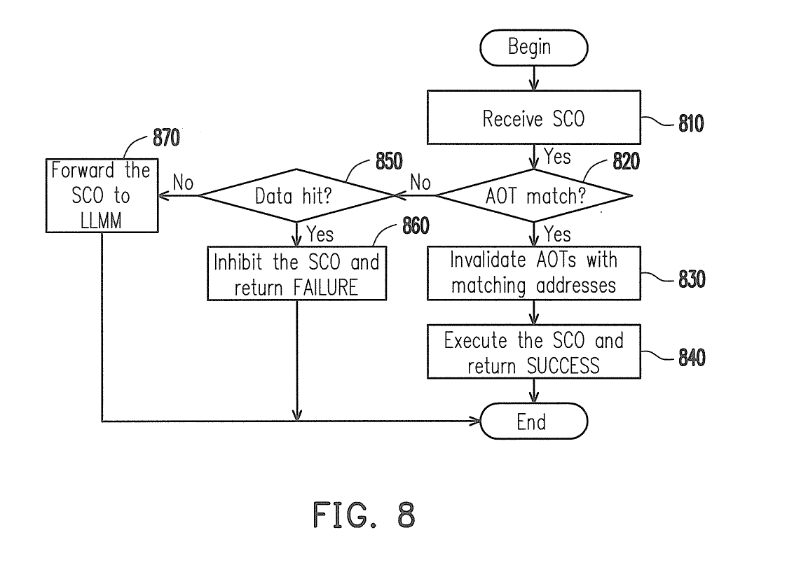

The flow of the handling process executed by the AOLU 230 is illustrated in the figures from FIG. 3 to FIG. 9. FIG. 3 and FIG. 4 show the first alternative of the handling process. FIG. 5 and FIG. 6 show the second alternative of the handling process. FIG. 7 and FIG. 8 show the third alternative of the handling process.

FIG. 3 shows the handling process for LLO of the first alternative, while FIG. 4 shows the handling process for SCO of the first alternative. The flow in FIG. 3 begins at step 310. First, the AOLU 230 receives the LLO of an atomic operation from a DPE or a ULMM of the MM 210 (step 310). Next, the AOLU 230 checks whether the cacheability of the LLO does not allow the MM 210 to keep a copy of the data to be accessed by the LLO or the cacheability of the LLO affiliates to the MM 210 (step 320). If the cacheability of the LLO allows the MM 210 to keep a copy of the data to be accessed by the LLO and the cacheability of the LLO does not affiliate to the MM 210, the AOLU 230 does nothing and the flow ends. Otherwise, the flow proceeds to step 330.

The aforementioned cacheability is an attribute of the memory address accessed by an atomic operation. The cacheability defines MMs on which levels in the MLMS are allowed to keep a copy of the data accessed by the atomic operation. The cacheability also defines cache writing policies of the memory address accessed by the atomic operation, such as write-through or write-back. The cacheability attribute is always included in the LLO and SCO of an atomic operation. The definition of cacheability affiliation is that the cacheability of an atomic operation affiliates to a MM when the MM is the most upper level the cacheability allows to keep a copy of the data addressed by the atomic operation.

Next, the AOLU 230 checks whether the LLO of the atomic operation is logged in the AOT unit 220 or not (step 330). If the LLO is not logged yet, the AOLU 230 logs the LLO as an AOT in the AOT unit 220 (step 340). If the LLO is already logged, the AOLU 230 does not log the LLO repeatedly. The flow skips step 340 and proceeds to step 345.

When the AOLU 230 logs the LLO in step 340, the AOLU 230 allocates the aforementioned AOT in the AOT unit 220 to record the key information of the LLO and then sets the AOT valid by writing a predetermined value into the valid bit of the AOT. The key information of the LLO includes the ID and/or the memory address of the atomic operation to which the LLO belongs. As discussed above, the ID and the memory address may be omitted. The AOLU 230 checks whether the LLO is logged or not in step 330 by comparing the key information of the LLO with the key information of the AOTs in the AOT unit 220. If the key information includes both the ID and the address, the AOLU 230 determines that the LLO is already logged in step 330 when there is an AOT in the AOT unit 220 with the same ID and address as those of the LLO. If the key information includes the ID or the address, the AOLU 230 determines that the LLO is already logged in step 330 when there is an AOT in the AOT unit 220 with the same ID or address as that of the LLO. When comparing the memory address of the LLO with the memory address of an AOT, the AOLU 230 may compare the full lengths of the addresses or a predetermined number of the most significant bits (MSBs) of both addresses. The aforementioned MSB comparison enables an AOT to cover a range of memory addresses.

Next, the AOLU 230 checks whether the cacheability of the LLO allows the MM 210 to keep a copy of the data to be accessed by the LLO after executing step 330 or 340 (step 345). If the cacheability of the LLO does not allow the MM 210 to keep a copy of the data to be accessed by the LLO, the AOLU 230 forwards the LLO to an LLMM of the MM 210 (step 350). Otherwise, the flow ends without performing step 350.

The LLO includes an operation of loading memory data into the DPE or the ULMM issuing the LLO. Loading memory data in an MLMS is conventional and well-known in the field of the present invention. Therefore, related details are omitted for brevity.

FIG. 4 shows the flow of SCO handling corresponding to the flow of LLO handling in FIG. 3. First, the AOLU 230 receives the SCO of an atomic operation from a DPE or a ULMM of the MM 210 (step 410). Next, the AOLU 230 compares the key information of the SCO with the key information of the AOTs in the AOT unit 220 in order to determine whether there is an AOT match or not (step 420). If there is no AOT match, the AOLU 230 inhibits the store operation of the SCO and returns a failure status to the DPE or the ULMM (step 430). If there is an AOT match, the flow proceeds to step 440. An AOT match means that there is an AOT in the AOT unit 220 with the same key information as that of the SCO. The key information of the SCO may include the ID and/or the memory address of the atomic operation to which the SCO belongs. The AOLU 230 compares the key information of the SCO with the key information of the AOTs in the same way as that in which the AOLU 230 compares the key information of the aforementioned LLO with the key information of the AOTs in the AOT unit 220.

If there is an AOT match, the AOLU 230 checks whether there is a data hit or not (step 440). A data hit means that the data to be accessed by the SCO is stored in the RMU 240 of the MM 210. If there is no data hit, the AOLU 230 forwards the SCO to an LLMM and returns the status returned by the LLMM to the DPE or the ULMM (step 450). If there is a data hit, the AOLU 230 invalidates all AOTs in the AOT unit 220 that match the memory address to be accessed by the SCO (step 460). The AOLU 230 invalidates every AOT with a matching address, no matter whether the ID of the AOT is the same as that of the SCO or not. In addition, depending on implementation, the AOLU may further issue an invalidation operation to its LLMMs to invalidate AOTs with the same address. All subsequent SCOs with matching addresses will fail because there will not be AOT match for them. Next, the AOLU 230 executes the store operation of the SCO and returns a success status to the DPE or the ULMM (step 470).

The details of the execution of the SCO may vary according to the cacheability of the SCO and the implementation of the AOLU 230. If there is a data hit, the data of the SCO is stored directly into the RMU 240 of the MM 210. The data of the SCO may be forwarded to an LLMM of the MM 210 when the cacheability indicates a write-through scheme or when there is no data hit. The details regarding storing data in an MLMS are conventional and well-known in the field of the present invention. Therefore, the details are omitted for brevity.

FIG. 5 and FIG. 6 show the flow of the second alternative of the handling process executed by the AOLU 230. FIG. 5 shows the flow for LLO handling, while FIG. 6 shows the flow for SCO handling.

In the LLO handling flow, firstly the AOLU 230 receives the LLO of an atomic operation from a DPE or a ULMM (step 510). Next, the AOLU 230 checks the cacheability of the LLO (step 520). If the cacheability of the LLO does not allow the MM 210 to keep a copy of the data to be accessed by the LLO, the AOLU 230 forwards the LLO to an LLMM of the MM 210 (step 530). If the cacheability of the LLO affiliates to the MM 210, the AOLU 230 checks whether the LLO is already logged in the AOT unit 220 or not (step 540). If the LLO is already logged, the AOLU 230 does nothing and the flow ends. If the LLO is not logged yet, the AOLU 230 logs the LLO as an AOT in the AOT unit 220 (step 550).

In the SCO handling flow, firstly the AOLU 230 receives the SCO of an atomic operation from a DPE or a ULMM (step 610). Next, the AOLU 230 checks the cacheability of the SCO (step 620). If the cacheability of the SCO does not allow the MM 210 to keep a copy of the data to be accessed by the SCO, the AOLU 230 forwards the SCO to an LLMM of the MM 210 and returns the status returned by the LLMM to the DPE or the ULMM (step 630). If the cacheability of the SCO affiliates to the MM 210, the AOLU 230 checks whether there is an AOT match or not (step 640). If there is no AOT match, the AOLU 230 inhibits the store operation of the SCO and returns a failure status to the DPE or the ULMM (step 650). If there is an AOT match, the AOLU 230 invalidates all AOTs in the AOT unit 220 that match the memory address to be accessed by the SCO (step 660). Next, the AOLU 230 executes the store operation of the SCO and returns a success status to the DPE or the ULMM (step 670).

FIG. 7 and FIG. 8 show the flow of the third alternative of the handling process executed by the AOLU 230. FIG. 7 shows the flow for LLO handling, while FIG. 8 shows the flow for SCO handling.

In the LLO handling flow, firstly the AOLU 230 receives the LLO of an atomic operations from a DPE or a ULMM (step 710). Next, the AOLU 230 checks whether there is a data hit or data allocation (step 720). A data hit means that the data to be accessed by the LLO is stored in the RMU 240 of the MM 210. Data allocation means that that the data to be accessed by the LLO will be brought into the RMU 240 of the MM 210 for the LLO. If there is no data hit and there is no data allocation, the AOLU 230 forwards the LLO to an LLMM of the MM 210 (step 730). If there is a data hit or data allocation, the AOLU 230 checks whether the LLO is already logged in the AOT unit 220 or not (step 740). If the LLO is already logged, the AOLU 230 does nothing and the flow ends. If the LLO is not logged yet, the AOLU 230 logs the LLO as an AOT in the AOT unit 220 (step 750). In addition, when any data in the RMU 240 is invalidated due to a cache memory replacement scheme implemented by the MM 210, the AOLU 230 invalidates all AOTs in the AOT unit 220 that match the address of the invalidated data.

In the SCO handling flow, firstly the AOLU 230 receives the SCO of an atomic operation from a DPE or a ULMM of the MM 210 (step 810). Next, the AOLU 230 checks whether there is an AOT match for the SCO or not (step 820). If there is an AOT match, the AOLU 230 invalidates all AOTs in the AOT unit 220 that match the memory address to be accessed by the SCO (step 830), executes the store operation of the SCO, and returns a success status to the DPE or the ULMM (step 840). If there is no AOT match, the AOLU 230 checks whether there is a data hit or not (step 850). If there is a data hit, the AOLU 230 inhibits the store operation of the SCO and returns a failure status to the DPE or the ULMM (step 860). If there is no data hit, the AOLU 230 forwards the SCO to an LLMM of the MM 210 and returns the status returned by the LLMM to the DPE or the ULMM (step 870).

The three alternatives of the handling process above have different advantages and disadvantages. The first alternative shown in FIG. 3 and FIG. 4 stores the AOT corresponding to the atomic operation in each MM from the first level MM directly connected to the DPE to the MM to which the cacheability affiliates to. Due to the distribution of AOTs and the processing flow of the first alternative, when the SCO of an atomic operation fails, the DPE receives a failure status immediately returned from the first level MM. Such a fast response shortens the waiting time of the DPE and improves efficiency. However, the repeated storage of AOTs is a waste of storage space in the AOT units, which may reduce the handling capacity for atomic operations of the MMs. In contrast, the second alternative shown in FIG. 5 and FIG. 6 stores only one AOT in the MM to which the cacheability affiliates. Similarly, the third alternative shown in FIG. 7 and FIG. 8 stores only one AOT in the MM where the data access by the atomic operation resides. The storage of AOTs in the second and the third alternatives is the most efficient in respect of storage space. However, the DPE that initiates an SCO has to wait until the SCO reaches the MM storing the AOT to receive the returned status according to the second and the third alternatives.

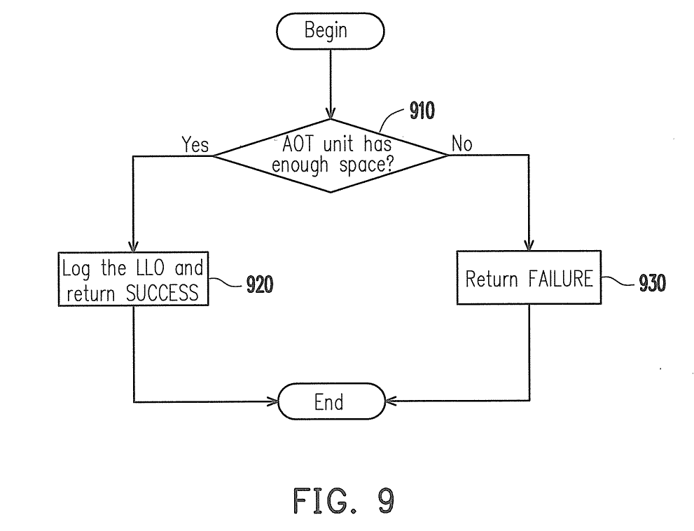

The LLO in the handling process above does not return a status. The execution of an LLO is always successful. In some other embodiments of the present invention, the LLO may return a status of success or failure. FIG. 9 is a flow chart showing the step of logging an LLO according to an embodiment of the present invention. Step 340 in FIG. 3, step 550 in FIG. 5, and step 750 in FIG. 7 may be replaced with the flow in FIG. 9.

According to the flow in FIG. 9, when the AOLU 230 needs to log an LLO as an AOT in the AOT unit 220, the AOLU 230 checks whether the AOT unit 220 has enough space to store the new AOT (step 910). If there is enough space for the new AOT, the AOLU 230 logs the LLO in the AOT unit 220 and returns a success status to the DPE or the ULMM that initiates the LLO (step 920). If the AOT unit 220 is already filled and there is no space for the new AOT, the AOLU 230 does not log the LLO and returns a failure status to the DPE or the ULMM (step 930). In an embodiment of the present invention, the LLO is issued by an instruction executed by the DPE. The DPE repeats executing the instruction in response to the failure status until the DPE receives the success status.

In an embodiment of the present invention, the SCO of an atomic operation is issued by an integrated store-or-branch-conditional instruction executed by the DPE. The store-or-branch-conditional instruction specifies a branch target address, in addition to required SCO operands. When the DPE receives the success status returned by the MM, the DPE executes the instruction following the store-or-branch-conditional instruction. When the DPE receives the failure status returned by the MM, the DPE executes another instruction located at the target address specified by the store-or-branch-conditional instruction in response. Alternatively, a branch instruction depending on the result of the SCO may be implemented to accomplish the same function together with the SCO.

In some embodiments of the present invention, a DPE may issue an invalidation operation to an MM. The invalidation operation includes the key information (ID and/or memory address) of a corresponding atomic operation. Upon receiving the invalidation operation, the AOLU of the MM invalidates all AOTs in the AOT unit with the same key information as that of the corresponding atomic operation. The MM may forward the invalidation operation to an LLMM to invalidate AOTs in the lower levels. Besides, an MM may issue an invalidation operation to an LLMM when executing an SCO of an atomic operation. For example, when a DPE is multi-tasking and switches from a task to another task. If the former task issued an LLO and the latter task issues another LLO, the DPE may issue an invalidation operation to clear the AOTs corresponding to the former LLO in order to ensure the consistency of AOTs in the MLMS or to collect some valuable storage space in the AOT units of the MMs.

There are three alternatives for the handling process executed by the AOLU in the aforementioned embodiments of the present invention. The present invention does not require that all MMs execute the same alternative of the handling process. Take the MLMS shown in FIG. 1 for example. The AOLU of the MM 121 may execute the first alternative shown in FIG. 3 and FIG. 4. The AOLU of the MM 122 may execute the second alternative shown in FIG. 5 and FIG. 6. The AOLU of the MM 123 may execute the third alternative shown in FIG. 7 and FIG. 8.

An MLMS may mix MMs supporting atomic operations with MMs not supporting atomic operations. In other words, it is feasible that only a part of MMs in an MLMS includes the AOLU and the AOT unit for handling atomic operations. When a particular MM includes the AOT unit and the AOLU, all ULMMs of the particular MM must also include the AOT unit and the AOLU. Otherwise the atomic operations will not work properly. When a particular MM does not include the AOT unit and the AOLU, all LLMMs of the particular MM does not have to include the AOT unit and the AOLU because the AOT unit and the AOLU of the LLMMs will not work properly.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A memory module for atomic operations in a multi-level memory structure (MLMS), comprising:
a regular memory unit (RMU), storing data of the memory module;
an atomic operation tag (AOT) unit, storing AOTs corresponding to the atomic operations; and
an atomic operation logic unit (AOLU), coupled to the RMU and the AOT unit, wherein the AOLU receives a load-locked operation (LLO) of one of the atomic operations from a data processing engine (DPE) or an upper level memory module (ULMM); the AOLU logs the LLO as an AOT in the AOT unit when a first condition is true; the AOLU forwards the LLO to a lower level memory module (LLMM) when a second condition is true.

2. The memory module of claim 1, wherein the ULMM connects to the memory module on a side nearer to the DPE, and the LLMM connects to the memory module on a side farther from the DPE.

3. The memory module of claim 1, wherein
the first condition is that a cacheability of the LLO does not allow the memory module to keep a copy of a data to be accessed by the LLO or the cacheability of the LLO affiliates to the memory module, and the LLO is not logged in the AOT unit;
the second condition is that the cacheability of the LLO does not allow the memory module to keep the copy of the data to be accessed by the LLO.

4. The memory module of claim 1, wherein
the first condition is that a cacheability of the LLO affiliates to the memory module and the LLO is not logged in the AOT unit;
the second condition is that the cacheability of the LLO does not allow the memory module to keep a copy of a data to be accessed by the LLO.

5. The memory module of claim 1, wherein
the first condition is that a data to be accessed by the LLO is stored in the memory module or will be brought into the memory module for the LLO, and the LLO is not logged in the AOT unit;
the second condition is that the data to be accessed by the LLO is not stored in the memory module and will not be brought into the memory module for the LLO.

6. The memory module of claim 5, wherein when a data in the RMU is invalidated due to a replacement scheme, the AOLU invalidates all AOTs in the AOT unit matching an address of the invalidated data.

7. The memory module of claim 1, wherein when the AOLU logs the LLO as the AOT in the AOT unit, the AOLU allocates the AOT in the AOT unit to record a key information of the LLO and then sets the AOT valid; the key information comprises an identification (ID) of the LLO and/or an address accessed by the LLO.

8. The memory module of claim 1, wherein the AOLU logs the LLO as the AOT in the AOT unit and returns a success status to the DPE or the ULMM when a third condition is true; the AOLU returns a failure status to the DPE or the ULMM when the third condition is false.

9. The memory module of claim 8, wherein the third condition is that the AOT unit has enough space to store the AOT.

10. The memory module of claim 8, wherein an instruction executed by the DPE issues the LLO and the DPE repeats executing the instruction in response to the failure status.

11. The memory module of claim 1, wherein the MLMS comprises a plurality of memory modules and some of the plurality of memory modules comprise an AOT unit an AOLU; when a particular one of the plurality of memory modules comprises the AOT unit and the AOLU, all ULMMs of the particular memory module also comprise the AOT unit and the AOLU; when the particular memory module does not comprise the AOT unit and the AOLU, all LLMMs of the particular memory module does not comprises the AOT unit and the AOLU, either.

12. A memory module for atomic operations in a multi-level memory structure (MLMS), comprising:
a regular memory unit (RMU), storing data of the memory module;
an atomic operation tag (AOT) unit, storing AOTs corresponding to the atomic operations; and
an atomic operation logic unit (AOLU), coupled to the RMU and the AOT unit, wherein the AOLU receives a store-conditional operation (SCO) of one of the atomic operations from a data processing engine (DPE) or an upper level memory module (ULMM); the AOLU invalidates all AOTs in the AOT unit matching a memory address to be accessed by the SCO, executes a store operation of the SCO, and returns a success status to the DPE or the ULMM when a first condition is true; the AOLU inhibits the store operation of the SCO and returns a failure status to the DPE or the ULMM when a second condition is true; the AOLU forwards the SCO to a lower level memory module (LLMM) and returns a status returned by the LLMM to the DPE or the ULMM when a third condition is true.

13. The memory module of claim 12, wherein the ULMM connects to the memory module on a side nearer to the DPE, and the LLMM connects to the memory module on a side farther from the DPE.

14. The memory module of claim 12, wherein
the first condition is that there is an AOT in the AOT unit with same key information as that of the SCO and a data to be accessed by the SCO is stored in the memory module;
the second condition is that there is no AOT in the AOT unit with same key information as that of the SCO;
the third condition is that there is the AOT in the AOT unit with same key information as that of the SCO and the data to be accessed by the SCO is not stored in the memory module.

15. The memory module of claim 12, wherein
the first condition is that a cacheability of the SCO affiliates to the memory module and there is an AOT in the AOT unit with same key information as that of the SCO;
the second condition is that the cacheability of the SCO affiliates to the memory module and there is no AOT in the AOT unit with same key information as that of the SCO;
the third condition is that the cacheability of the SCO does not allow the memory module to keep a copy of a data to be accessed by the SCO.

16. The memory module of claim 12, wherein
the first condition is that there is an AOT in the AOT unit with same key information as that of the SCO;
the second condition is that there is no AOT in the AOT unit with same key information as that of the SCO and a data to be accessed by the SCO is stored in the memory module;
the third condition is that there is no AOT in the AOT unit with same key information as that of the SCO and the data to be accessed by the SCO is not stored in the memory module.

17. The memory module of claim 12, wherein a store-or-branch-conditional instruction executed by the DPE issues the SCO and the DPE executes another instruction located at a target address specified by the store-or-branch-conditional instruction in response to the failure status.

18. A method for atomic operations in a multi-level memory structure (MLMS), executed by a memory module of the MLMS, comprising:
the memory module receiving a load-locked operation (LLO) of one of the atomic operations from a data processing engine (DPE) or an upper level memory module (ULMM);
the memory module logging the LLO as an atomic operation tag (AOT) in the memory module when a first condition is true; and
the memory module forwarding the LLO to a lower level memory module (LLMM) when a second condition is true.

19. A method for atomic operations in a multi-level memory structure (MLMS), executed by a memory module of the MLMS, comprising:
the memory module receiving a store-conditional operation (SCO) of one of the atomic operations from a data processing engine (DPE) or an upper level memory module (ULMM);
the memory module invalidating all atomic operation tags (AOTs) in the memory module matching a memory address to be accessed by the SCO, executing a store operation of the SCO, and returning a success status to the DPE or the ULMM when a first condition is true;
the memory module inhibiting the store operation of the SCO and returning a failure status to the DPE or the ULMM when a second condition is true; and
the memory module forwarding the SCO to a lower level memory module (LLMM) and returning a status returned by the LLMM to the DPE or the ULMM when a third condition is true.
